(19) United States
(12) Patent Application Publication
(10) Pub. No.: US 2006/0041462 A1
(43) Pub. Date: Feb. 23, 2006

(54) Method to route jobs

(76) Inventor: Ulrich Waibel, Vienna (AT)

Correspondence Address: PHILIPS INTELLECTUAL PROPERTY & STANDARDS, P.O. BOX 3001, BRIARCLIFF MANOR, NY, 10510, US

(21) Appl. No.: 10/524,568

(22) PCT Filed: Aug. 5, 2003
(86) PCT No.: PCT/IB03/03486

§ 371 Date: Feb. 15, 2005

(30) Foreign Application Priority Data
Aug. 20, 2002 (EP) 02102200.9

(51) Int. Cl. G06F 15/02

(52) U.S. Cl. 705/9

(57) ABSTRACT

For the automatic routing of jobs of different types to persons who will undertake the jobs, means (4) for establishing the type of a job to be routed when a job request arrives, means (6) for storing personal parameters of persons assigned to the types of jobs, means (5) for establishing at least one person who, on the basis of the stored personal parameters, is suitable for undertaking the particular job, based on its type, and means (12) for automatically forwarding the processing request to the person established as suitable are provided, which means (12) for automatic forwarding are connected to the means (5) for establishing at least one suitable person.

The invention relates to a device for the automatic routing of jobs of different types to persons who undertake the jobs.

The invention further relates to a system comprising multiple workstations with means for processing information, and comprising a device of this kind for routing jobs.

Finally, the invention also relates to a method for the automatic routing of jobs of different types to the persons undertaking the jobs.

A typical area in which different types of jobs—or information—occur is the transcription of dictations, wherein voice recognition means are frequently used here for the automatic creation of text files, the output files of which voice recognition means are subsequently checked and, where applicable, corrected by a person, listening to at least parts of the dictation. Apart from the word processing steps that are conventional per se, such as the deletion of characters, overtyping of characters and insertion of characters, this processing activity thereby also comprises listening to the dictation, wherein the fast or slow playing or activation of certain dictation passages, the rapid skipping of dictation passages, text formatting and other processing activities have to be performed by persons, depending on their aptitude, which activities are undertaken in relation to the particular job type, which in this case derives from the particular author with his dictating individualities, from the way in which the dictation is transmitted (e.g. telephone, tape . . . ) and the factual content of the dictation (e.g. medical texts, legal texts, reminder letters etc.).

A situation that is entirely comparable is that of the processing of image information, e.g. in the area of advertising graphics or architecture. Here, for example, compilations of stored pixels are revised with reference to the size and arrangement of these pixels, coloration etc., wherein, as in the case of processing text information, typical individual processing steps, such as enlargement, reduction, moving of pixels, overlaying with different colors etc. apply, depending on type, and some persons are more suited to these processing operations, and others less.

A further application area is the processing of translation texts produced automatically using a translation program, wherein, as with the transcription of dictations and the revision of text information, individual processing operations have to be performed in the course of the word processing, in this case using a defined text in a foreign language. Here, the job type is determined firstly by the foreign language, but also by the content of the text.

As already indicated above, different persons have quite different aptitudes for different types of jobs, for instance, one person may have already processed dictation files or texts from a particular author on many occasions and thereby become accustomed to his dictation individualities, or a person undertaking the processing has some familiarity with certain specialist fields of the texts, such as surgery, internal medicine etc., and has gained a basic knowledge in these specialist areas. The present invention is based on the exploitation of these specific aptitudes so that improved services can be offered when complying with processing requests or jobs.

Already known from patent document U.S. Pat. No. 3,965,484 A is a central dictation system in which multiple transcription workstations are provided. The dictation length at a particular workstation can hereby be established, as can the length of the text already transcribed or processed. The respective available work capacity can thereby be determined for each workstation, wherein information can also be obtained as to how long the particular person still has to work on a particular processing job, or when they are anticipated to be free again for a further job. The system is controlled by a monitoring center to ensure that all persons are uniformly occupied, i.e. to optimize intake capacity. As a result, the entire throughput is, of course, improved, but processing jobs are only ever routed to persons who have just become free or are about to become free without any account being taken of their suitability for the particular type of job. It may happen that, for example, difficult chemical or medical texts are routed for processing to a person who has previously processed only simple letters, such as reminders or texts in the field of mechanical engineering; as a result, a comparatively inefficient processing can be anticipated to the extent that the processing takes a long time and/or the final text contains errors.

It is an object of the invention to remedy this situation and to make available a device and a method and a system as specified above, in order that, through a matched routing of jobs of different types to particularly appropriate persons, a significant improvement in processing efficiency can be achieved.

Accordingly, in accordance with a first aspect, in order to achieve this object, the invention provides a device for the automatic routing of jobs of different types to persons who will undertake the jobs, with means for establishing the type of a job to be routed when a job request arrives,

means for storing personal parameters of persons assigned to types of jobs

means for establishing at least one person who, on the basis of the stored personal parameters, is suitable for undertaking the particular job, based on its type

means for automatically forwarding the processing request to the person established as suitable, which means for automatic forwarding are connected to the means for establishing at least one suitable person.

In accordance with a second aspect, in order to achieve the stated object, the invention provides a system comprising a plurality of workstations, comprising means for processing information made available in electronic form, and comprising a device for routing the jobs as specified above.

In accordance with a third aspect, in order to achieve the stated object, the invention provides a method for automatically routing jobs of different types to persons undertaking the jobs, wherein the type of the particular job to be routed is established, and a person suitable to undertake the processing is established on the basis of the stored personal parameters assigned to the types of jobs, to which person the job is routed.

With the technology in accordance with the invention, an automatic routing that is specific to the particular type of job takes place to a person who, on the basis of the available personal parameters, is anticipated to be particularly suitable for this type of job. The personal parameters, which are matched to the particular type of job, and which are a measure of efficiency or productivity, are established and stored, in particular, on the basis of historical data, i.e. on the basis of earlier jobs, wherein their assignment to the particular type of job is recorded. The type of job may be determinable, for example in the case of transcription of dictations, on the basis of the particular author, the form of transmission of the dictation file (electronically as normal, for example, or using a tape or even via a telephone connection, which experience has shown will be subject to interference, etc.) or on the basis of the content of the dictated text. Depending on the text content, the author and form of transmission, or, depending on the type of job generally, the person who should be, per se, best suited to this type of job is then determined by means of the stored personal efficiency parameters for the various persons. Since it is possible that this person judged to be best suited may be temporarily unavailable, for example because he is already undertaking a job or because he has a day's holiday, etc., or because the undertaking of the job to be routed cannot be postponed to a later time, it is expedient to compile a list of suitable persons, ranked according to their suitability for the current job type on the basis of the personal parameters, on each arrival of a job of this kind. This list, compiled for the particular type of job, may then be worked through as regards the checking of other boundary conditions, such as availability or, if applicable, the suitability of the computing means assigned to this person, wherein the availability of the person is established, for example on the basis of stored information on working hours and/or on the basis of continuously determined information concerning the current workloading of this person.

As already mentioned, the jobs to be undertaken preferably involve the processing of information provided in electronic form, especially text information compiled automatically with the aid of voice recognition means on the basis of dictations by authors. The type of the particular job may hereby be established on the basis of the establishment of the specialist field and/or the author of the particular dictation.

It is ensured in this manner that the processing job is undertaken outstandingly efficiently, wherein the processing job is always routed to a person who is well suited to it—and therefore efficient—and in respect of whom, on the other hand, it is ensured that the job can be undertaken in the required time. As a result, a cost-efficient accomplishment of jobs can also be ensured, and the entire throughput of jobs can be optimized. The routing of processing jobs hereby takes place fully automatically, without any manual intervention on the part of a central supervisor, in a completely neutral, reliable manner.

The invention will be further described with reference to examples of embodiments shown in the drawings, to which, however, the invention is not restricted.

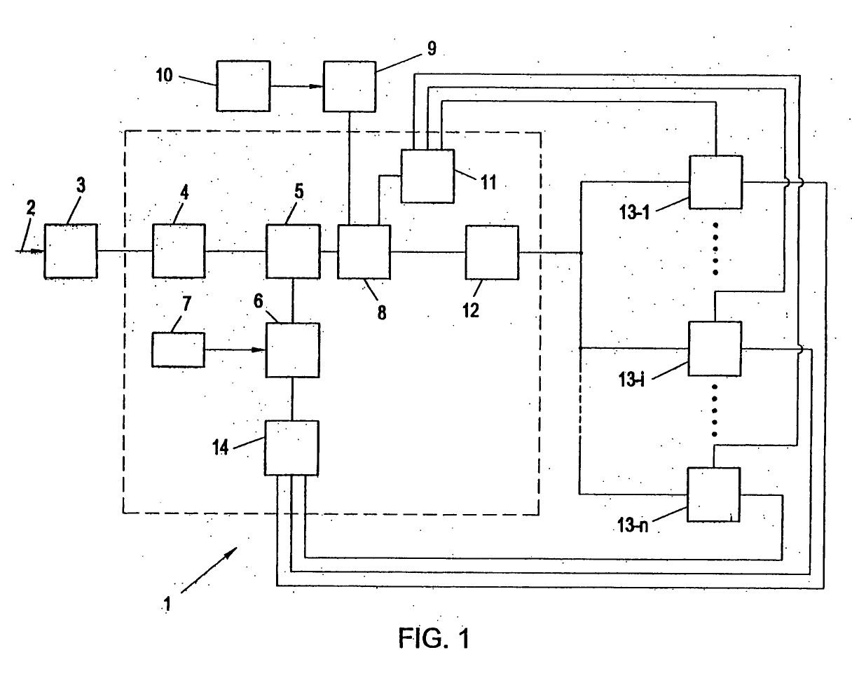

FIG. 1 shows schematically, in the form of a block diagram, a device for the automatic routing of jobs of different types to persons, wherein the workstations assigned to these persons are shown symbolically in the block diagram.

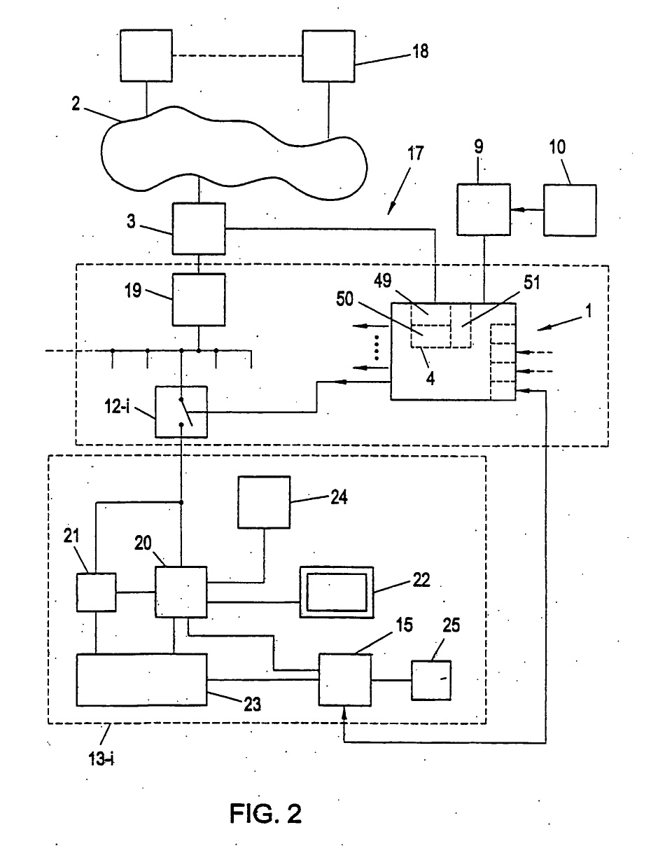

FIG. 2 shows, in the form of a block diagram, a system for processing information with a device of this kind for the automatic routing of jobs, wherein an individual workstation, equipped with computing means for processing the information, is shown by way of an example of multiple workstations of this kind.

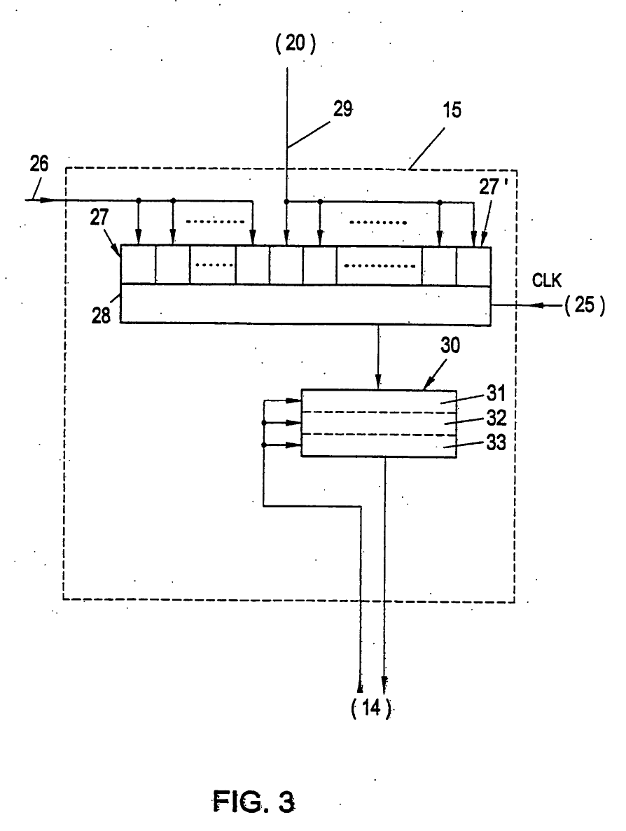

FIG. 3 shows, again in the form of a block diagram, means for recording individual processing operations involved in the processing of information in a system as shown in FIG. 2, wherein this recording of processing operations forms the basis for determining personal efficiency parameters to be stored.

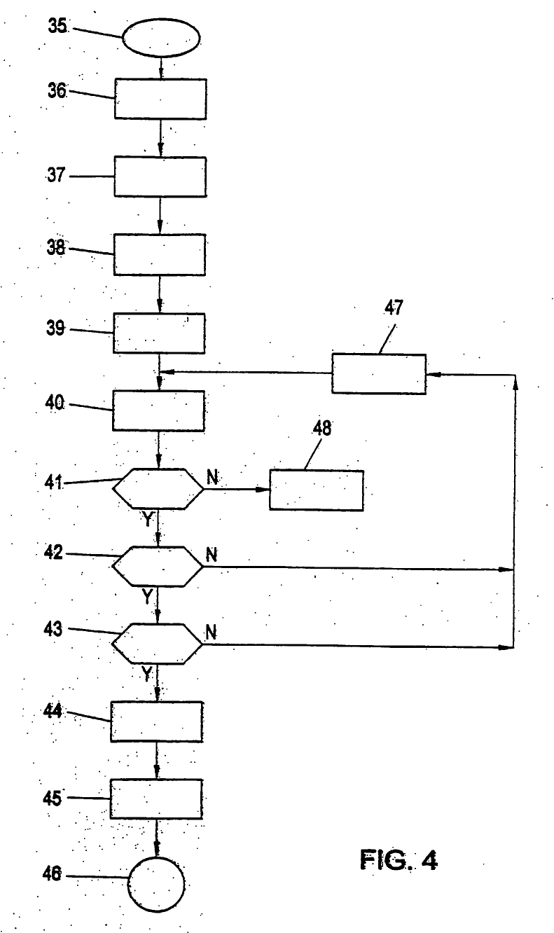

FIG. 4 shows, in the form of a flowchart, a possible work method of a system of this kind for processing information comprising a device for the automatic routing of jobs.

FIG. 1 shows, quite generally, a device 1 for the automatic routing of jobs of different types to persons who are to undertake these jobs. The processing requests or jobs hereby pass via a communication connection 2 to a receiver unit 3. Serving as communication connection 2 may be, for example, a telephone connection, an Internet connection, a LAN or WAN connection, etc. Received as processing requests or processing jobs may be, for example, a dictation to be transcribed from a client or author, but any other kind of processing request or job may be present, such as a request or job for the automatic production of a translation and the processing of this translation, an order for processing image information, etc.; in principle, a processing request may even be a simple phone call at a call center, e.g. to obtain information about certain items from a mail order company, to order items by telephone, to make telephone inquiries concerning a consignment of items, to make complaints by telephone about delivered items and/or about invoices received. Depending on the type of processing requested, device 1 undertakes a routing to a person who, on the basis of historical values or of special training for this type of job, is particularly suitable, so that the most efficient possible processing is ensured. What is meant by “efficient” processing may be especially rapid and/or qualitatively good processing of, for instance, text information or image information, but it may also be processing that is especially satisfactory to a calling client—e.g. in the form of a detailed factual explanation in the case of a telephone complaint to a call center.

As shown in FIG. 1, the device 1 for automatic routing comprises a means 4 for establishing the type of the requested job to be routed, which is connected to reception unit 3. Connected to this means 4 for establishing the job type is a means 5 for determining persons especially suited to this type of job. Determination of the persons to whom the job will be routed takes place on the basis of personal parameters, coordinated with the job type, which are read from a means 6 for storing these personal parameters. Stored in this memory means 6 may be the parameters associated with each person, coordinated with the job type, which are referred to below as (personal) efficiency parameters, as well as already created lists of persons relating to the possible job types, ranked according to their suitability in accordance with their personal efficiency parameters. In the case of the transcription of dictations, in order to compile the personal efficiency parameters, account may, for example, be taken here of information, referred to each author and each specialist field of a dictation to be transcribed, concerning average completion times per page, costs per minute, character inputs (keystrokes) per minute or total throughput times, and also data concerning the number or length of rewinding operations involved in transcribing dictations or self-corrections. In this example, these personal efficiency parameters or productivity parameters are thereby compiled in relation to the client (author) and the specialist field of the dictation so that, on the one hand, specific individualities of the author when dictating and, on the other, specific difficulties of the text information to be produced as regards its content are recorded, e.g. if it is a medical, technical or legal article or simply a general letter. The determination of these personal efficiency parameters is described in greater detail below, but it can be stated at this point that a continuous updating of the stored efficiency parameters every time a job is undertaken is preferably provided. In the case of persons undertaking jobs for the first time, an input unit 7 for the manual inputting of initial personal efficiency parameters may also be assigned to memory means 6, wherein, after the first job, these efficiency parameters can be replaced with the parameters determined on the basis of this job.

The means 5 for determining the persons for undertaking the particular job is preferably a means for compiling a list of suitable persons, which is compiled for the particular processing job as it arises, with recourse to the efficiency parameters stored in memory means 6, or which is read, when needed, after an earlier compilation; in principle, selected from this list to undertake the required job would be the person who is at the top and who is thereby expected to be the best suited to it, but this is possible only if the person is still at his workstation and will be there for a sufficient time to undertake the job, and also if his current workload allows such a routing. Accordingly, a means 8 for selecting an available person from the list of persons compiled in means 5 is connected to this means 5, and this selection means 8 is further connected to a memory means 9, in which general working-time information relating to all persons is stored. This working-time information can be sent to memory means 9 via a working-time inputting means 10, such as a keyboard, an electronic time-recording apparatus or similar. Selection means 8 is further connected to a means 11 for recording and storing information concerning the current workloading of all persons in order that the routing of the processing job may also be undertaken specifically according to the loading of the individual persons. In the simplest case, means 11 hereby contains information of a kind such that, for example, the person concerned is presently undertaking one job and so is currently unavailable for another. This would be provided in this way in the above-mentioned example of a call center. In the case of the transcription of dictations and similar jobs, however, information concerning workloading may be recorded and stored in means 11 in a way such that a particular person is currently occupied with processing some automatically transcribed text information and that this activity is anticipated to last for a further time x. If the result of the new processing job is not required until later, a sufficiently long time after time x, and the person concerned is the person best suited for that type of job, much the most efficient procedure may therefore be to route the job to this person as his next processing job; if, however, the result of the processing is required earlier, before the expiry of time x or shortly after, then, on the basis of the still-continuing occupation of this person who is best suited per se, the person shown in the list as the next-best free person would be selected and the processing job would be routed to that person.

For the routing itself, device 1 comprises a means 12 for the automatic forwarding of the processing request or job to the selected person, i.e. to one of various workstations 13-1, . . . , 13-i, . . . , 13-n. (Below, for reasons of simplicity, reference will be made exclusively to a workstation 13-i, with i=1-n, wherein n specifies the total number of workstations and thereby of persons). Means 12 for the automatic forwarding of the processing job may be, for example, addressing means which provide the processing job with an address code corresponding to one of workstations 13-i, with i=1-n, wherein the workstations 13-i contain corresponding address decoding means (not shown) in order to recognize and receive the processing jobs addressed and transmitted to them. The most diverse different embodiments are, of course, also conceivable for means 12 for the automatic forwarding of the processing jobs, and FIG. 2 accordingly also shows, symbolically, this means for automatically forwarding the processing jobs as switch means 12-i assigned to the individual workstations 13-i, i.e. as means for automatic forwarding in the form of a “switching-through” of the processing jobs to the relevant workstation 13-i. An associated switching means 12-i of this kind for the forwarding of processing jobs from the receiver unit 3 to the associated workstation 13-i should hereby be conceived for each workstation 13-i.

Finally, as shown in FIG. 1, each workstation 13-i is further connected to a central means 14 for determining the above-mentioned personal efficiency parameters, coordinated with the job type, wherein the above-mentioned memory means 6 for storing the personal efficiency parameters is connected to this parameter determination means 14. The means 14 for parameter determination may be connected to a means 15 (see FIG. 2) for recording processing operations, which is assigned to the individual workstations 13-i, but it may also be combined with means of this kind for recording processing operations to form a central unit. The operating mode of these means 14, 15 for determining the parameters and for recording processing operations is described in greater detail below with reference to FIG. 3.

The broken outline 16 in FIG. 1 indicates that components 4 to 8, 11, 12 and 14 may be components of a general computing unit, e.g. a PC.

FIG. 2 shows, as a preferred example of the processing of information with an automatic routing of the processing jobs, a system 17 for the transcription of a dictation and revision of the text thereby produced automatically with the aid of voice recognition software. As mentioned, however, the invention is of course not restricted to a system of this kind, but may also be applied to other systems for the processing of information, such as systems for the production of translations with the aid of translation software and for processing the automatically produced, translated text, or systems for processing images for advertising firms or architects.

Outlined with broken lines in FIG. 2 is a transcription workstation 13-i, which, together with other transcription workstations, is part of the system 17 for processing text information. The above-mentioned receiver unit 3 is assigned to these transcription workstations 13-i in order to receive transcription jobs from one of multiple clients 18 via communication connection 2, for example via an Internet LAN or WAN connection. Reception unit 3 is realized with the aid of, for example, a modem, in order to enable communication—i.e. receiving and, preferably, also sending—via the Internet, wherein, in the case of LAN or WAN, other communication means may also be used. The transcription jobs are dictation files, present in electronic form, each of which is to be converted into a text file, and, to this end, is sent to an automatic voice recognition means 19, which is preferably provided centrally in system 17, e.g. in conjunction with device 1, which is also provided centrally, and which is provided with a buffer storage means, which is not shown, for the intermediate storage of the dictation files and/or text files. With the aid of this automatic voice recognition means 19, a text file is created in a manner that is known per se and will therefore not be further described here, which text file is sent selectively, via the above-mentioned switch means 12-i or, generally, via means for automatic forwarding, to the relevant workstation 13-i or to means provided there for undertaking individual work operations involved in processing the information contained in the text file—a word processing means 20. Simultaneously, the dictation file associated with the text file is sent to a reproduction means 21, which is connected to word processing means 20, to enable a reproduction of the dictation that is coordinated with the displaying on a screen 22 of sections of text contained in the text file. Assigned to word processing means 20 and reproduction means 21 is an inputting means 23, wherein the inputting means in this case constitutes, in particular, a keyboard, preferably combined with a mouse.

The means 20 and 23 described are realized by, for example, a computer, in particular a PC, with a screen, wherein a means 24 for supplying the processed information contained in the text file is also provided, which is realized in the present case with the aid of memory means 24. Memory means 24 is provided for storing the processed final information—i.e. for supplying this information. It may be mentioned that a text output unit, not shown in FIG. 2, may be provided, which may be connected to word processing means 20 or to memory means 24, wherein the text output unit may be realized with the aid of a printer. Also provided as the word processing unit, however, may be the unit 3, which then takes the form of a sender/receiver unit, in order to return the created text files to the client 18, via communication connection 2, in electronic form.

Further assigned to the inputting means 23 and word processing means 20 is the above-mentioned means 15 for recording processing operations involved in the processing of the text that was initially automatically created with the aid of automatic voice recognition means 19, and for creating information (dimensions) for detailed working stages that take place thereby. This means, referred to below as efficiency recording means 15 for short, is further explained below with reference to FIG. 3. This efficiency recording means 15 is provided to record or measure the amount of work or time expended in association with individual activities during the processing of the automatically created text in the word processing means 20, to which end a clock-pulse generator means 25 is provided in order to send a clock signal to the efficiency recording means 15 as the time basis. The information specifying efficiency as derived from efficiency recording means 15 is then sent to the means 14 (see FIG. 1) for determining the personal efficiency parameters specific to job type. This parameter determination may hereby take place continuously—with each new processing of information—in order that up to date efficiency parameters are thereby always available in memory means 6 (see FIG. 1).

Although this is not illustrated in the drawing, the recording of processing operations involved in the processing of text information as regards e.g. their duration may comprise both the monitoring of the actuation of inputting means 23, e.g. the actuation of certain keys of a keyboard such as the cursor key, delete key or overtype key, and the monitoring of corresponding control signals either in the word processing means 20 directly and/or the monitoring of switching fields on the screen 22, which are triggered via the word processing means 20 but are not shown. Control commands for the reproduction means 21, such as fast-forwarding, rewinding, slow-play or fast-play of dictations, may also be recorded in terms of the nature and duration of these operations.

This is illustrated with reference to FIG. 3, in which the layout of one embodiment of efficiency recording means 15 is shown in greater detail. Signal sequences that are received in response to certain inputs, especially key actuations, or to certain dictation reproduction commands, are hereby sent via a connection 26 to recognition modules 27 within efficiency recording means 15, which recognize the individual signal sequences according to their type, e.g. on the basis of a comparison with stored sequences; these signals or operations are then measured in respect of their duration, to which end a measuring means 28 is provided, to which the clock signal CLK from the clock-pulse generator means 25 (see also FIG. 2) is also sent. In a comparable manner, word-processing signal sequences are sent from word processing means 20, via a connection 29, to recognition modules 27′, so that, on recognition of these word-processing signal sequences, recording in terms of time is realized in measuring means 28.

The information thereby obtained in respect of the duration of processing operations that have just been performed is then sent to processing means 30 in order for the duration of the same kind of actions or individual processing operations to be totaled up in summation means 31, after which, in normalizing means 32, the totaled information is related to predeterminable work units, such as time units or lines of text; processing means 20 also contains supply means (memory means 33) to keep the thus prepared, i.e. totaled and normalized, efficiency information available for reading by the parameter determination means 14 (see FIG. 1). From this efficiency information, such as time information for fast forward dictation, rewind dictation, listen (slowly) to dictation, search for text characters, overtype characters, delete characters, insert characters etc., means 14 determines a personal efficiency parameter, depending on the ideal target, according to a predetermined algorithm, e.g. by weighting of the individual processing steps and totaling of the weighted processing steps. As regards the recording of the individual processing steps in terms of time in measuring means 28, it is also easily possible to record pauses between individual processing steps with a duration longer than a minimum duration (e.g. 5 or 10 or 20 s), and to subsequently total them in order that the total pause times during the processing of a text file may also be shown.

In totaling the efficiency information in summation means 31 and normalizing in normalizing means 32, provision may also be made for the efficiency information to be continuously averaged with reference to a line of text, i.e. after the processing of a page of text, the average duration of deletion processes or insertion processes per line of text can be established. In order that particular requirements can be set selectively as desired, control inputs of means 31, 32 and 33 are connected via a control connection 34 to means 14 for parameter determination. This parameter determination means 14 may hereby be equipped with inputting means not shown in the drawing, in order that control information of this kind may be sent via control connection 33 to the control inputs of means 30, 31 and 32, and likewise the nature of the particular parameter determination can be defined with this inputting means.

FIG. 4 shows schematically, by way of example, a routine for the automatic routing of jobs of different types to persons who will undertake the jobs. After the start at a block 35, when a processing job, namely, by way of example, a transcription job, arrives, the type of job is determined, depending on the author and specialist field, at a block 36, e.g. job type “T1” (e.g. author x1, specialist field y1, for instance “internal medicine”). At a block 37, all possible processors Bi, with i=1 to n, for this job type T1 are then determined. Simultaneously, the system capacity in general can also be determined during this step.

At a block 38, all processors Bi are then recorded in a list, ranked according to their personal efficiency parameters Ei, referred to the job type T1, wherein the persons having the best efficiency parameter Ei (T1) for the given job type T1 are first on the list. This ranking should, of course, be regarded as relating to the special job case, in the light of the given author and the given specialist field, and different rankings of persons Bi will, of course, obtain in the case of other authors and/or other specialist fields, owing to the different efficiency parameters Ei (Tk) then applying.

The best available processor person then has to be determined automatically on the basis of other boundary conditions. To this end, at a block 39, an index i assigned to the persons (a consecutive number) is set to “1”, i.e. the processor person positioned first on the list created at block 38 is determined as person B1, which takes place at a block 40. At a block 41, an inquiry is then made as to whether index i is less than or, at most, equal to the maximum number n of processor persons (i.e. i≦n?); if this is the case, an inquiry takes place at a block 42 as to whether the person Bi who is being checked is present at his workstation 13-i, i.e. whether his workstation 13-i is active. This can also be decided on the basis of the general working-time information contained in memory means 9 in accordance with FIG. 1. If the result of this inquiry at block 42 is that person Bi is available per se, an inquiry is then made at a block 43 as to the current personal workloading, i.e. a check is made as to whether or not the workloading of this person Bi permits a routing of the processing job. If the routing is permissible, the processing job is routed to this person Bi at a block 44. This person Bi then undertakes the job in accordance with a block 45, wherein, in the course of the job, the efficiency information, as described with reference to FIG. 3, is also determined and updated. Subsequently, the end of the routine is reached in a field 46.

If it is established at block 43 that the current personal loading is such that a routing of the new processing job is not possible, there is a return to block 40 via a block 47, at which index i is increased by one (as i=i+1). This also occurs if it is established at block 42 that the person currently being checked is unavailable, e.g. has already left his workstation.

If it is established at block 41 in the course of the check that all n persons on the list have been checked and found to be unavailable, a new person may be determined at a block 48, to whom the processing job will then be routed.

Notwithstanding the above-described methodology, a list of suitable processor persons, ranked according to their personal efficiency parameters, may also be continuously created and kept stored in means 5 as shown in FIG. 1, for every possible processing job type T, i.e. irrespective of the arrival of a processing job (see block 35 in FIG. 4), the step in accordance with block 38 in FIG. 4 would take place beforehand. Accordingly, it would be not just the personal efficiency parameters of the various persons that would be stored in memory means 6, but also lists of persons ranked according to the efficiency parameters referred to the particular job type. This requires a somewhat higher memory capacity, but can lead to quicker routing operations since, when a processing job arrives, as soon as the job type Tk has been established in means 4, a particular list L (Tk) can be accessed in memory means 6, i.e. in general, no immediate calculation operations or ranking operations for the purpose of creating ad hoc lists need then be undertaken.

As explained above with reference to FIG. 4, job type T is, for example, determined (at block 36) with the aid of information concerning the author and specialist field. In order to undertake this special method of establishing the job type, as explained in FIG. 2 by way of example, the associated means 4 may comprise means 49 for establishing the author, e.g. by comparison with information in a memory 51, and means 50 for establishing the specialist field, again, for example, on the basis of a comparison with information stored in memory 51.

Also used as personal efficiency parameters, referred to the particular job type, may be cost information, such as the costs per minute of working time of a person, if fixed costs for a particular text unit to be processed are to be taken as the basis.

In the case of different systems for processing information, other corresponding efficiency parameters specific to the particular system may be defined, albeit that, depending on job type, these efficiency parameters can, in most cases, be best derived from the particular processing time required, whatever the normalization (i.e. referred to text units, pages of images etc.).

In all cases, an automatic routing of arriving jobs, in accordance with the particular type, to processing persons particularly suited to undertake them is enabled with the present technology, as a result of which it is ensured that every processing job is executed in the most efficient manner. As a result, costs can be minimized, and the total throughput or productivity of the system can also be maximized. As can be seen, the present technology thereby extends beyond purely a minimization of processing times or a simple comparison of the workloads of processor persons.

1. A device (1) for the automatic routing of jobs of different types to persons who will undertake the jobs, with
means (4) for establishing the type of a job to be routed when a job request arrives,
means (6) for storing personal parameters of persons assigned to types of jobs
means (5) for establishing at least one person who, on the basis of the stored personal parameters, is suitable for undertaking the particular job, based on its type
means (12) for automatically forwarding the processing request to the person established as suitable, which means (12) for automatic forwarding are connected to the means (5) for establishing at least one suitable person.

2. A device as claimed in claim 1, wherein the means (5) for establishing at least one suitable person are means for creating a list of suitable persons, ranked according to their suitability on the basis of the personal parameters.

3. A device as claimed in claim 2, further equipped with memory means (9) for storing working-time information and with means (8) for selecting a person from the list on the basis of their ranking in the list and on the basis of working-time information read from memory means (9).

4. A device as claimed in claim 2, further equipped with means (11) for recording information concerning the current workloading of individual persons, and with means (8) for selecting a person from the list on the basis of their ranking in the list and on the basis of the information concerning their current workloading.

5. A device as claimed in claim 2, further equipped with memory means (9) for storing working-time information for the individual persons, with means (11) for recording information concerning the current workloading of the individual persons, and with means (8) for selecting a person from the list on the basis of their ranking in the list, on the basis of working-time information read from memory means (9) and on the basis of information concerning the current workloading.

6. A device as claimed in claim 1, in which the means (6) for storing the personal parameters is connected to a means (14) for the continuous determination of these personal parameters on the basis of each job undertaken by the person.

7. A system (17) comprising multiple workstations (13-i) with means (20) for processing information made available in electronic form, and comprising a device (1) for routing the jobs, as claimed in claim 1.

8. A system as claimed in claim 7, with means (19) for voice recognition and for the creation of text information on the basis of dictations by authors, wherein the workstations (13-i) are transcription workstations for the processing of text information.

9. A system as claimed in claim 8, wherein the means (4) for establishing the type comprises a means (50) for establishing the specialist field of the particular dictation.

10. A system as claimed in claim 8, wherein the means (4) for establishing the type comprises a means (49) for establishing the particular author.

11. A method for the automatic routing of jobs of different types to persons who undertake the jobs, wherein the type of the particular job to be routed is established, and a person suitable to undertake the job is determined on the basis of stored personal parameters assigned to the types of jobs, to which person the job is routed.

12. A method as claimed in claim 11, wherein a list of suitable persons, ranked according to their suitability established on the basis of the personal parameters, is created for the particular job type.

13. A method as claimed in claim 12, wherein the person who is both best suited and available is established from the created list on the basis of the personal parameters.

14. A method as claimed in claim 13, wherein the availability of the person is established on the basis of stored working-time information.

15. A method as claimed in claim 13, wherein the availability of the person is established on the basis of continuously determined information concerning the current workloading of this person.

16. A method as claimed in claim 13, wherein the availability of the person is established on the basis of stored working-time information and of continuously determined information concerning the current workloading of this person.

17. A method as claimed in claim 11, wherein jobs involving the processing of information made available in electronic form are routed.

18. A method as claimed in claim 17, wherein the information to be processed is text information compiled automatically with the aid of voice recognition means (19) on the basis of dictations by authors.

19. A method as claimed in claim 18, wherein, to establish the type of the particular job, the specialist field of the particular dictation is established.

20. A method as claimed in claim 18, wherein, to establish the type of the particular job, the particular author is established.
